(19) United States
(12) Patent Application Publication
(10) Pub. No.: US 2016/0308407 A1
(43) Pub. Date: Oct. 20, 2016

(54) Stator Core Comprising a Flow-Path Barrier

(71) Applicant: Hilti Aktiengesellschaft, Schaan (LI)

(72) Inventor: Thomas Mahler, Laage (DE)

(73) Assignee: Hilti Aktiengesellschaft, Schaan (LI)

(21) Appl. No.: 15/101,629

(22) PCT Filed: Dec. 1, 2014
(86) PCT No.: PCT/EP2014/076045

§ 371 Date: Jun. 3, 2016

(30) Foreign Application Priority Data
Dec. 4, 2013 (EP) 13195701.1

(51) Int. Cl. H02K 1/16; H02K 1/14; H02K 3/34; H02K 15/02

(52) U.S. Cl. CPC H02K 1/165; H02K 15/022; H02K 1/146; H02K 3/345

(57) ABSTRACT

A stator core for use in an electromagnetic machine is disclosed. The stator core contains at least one first lamination and one second lamination each of which has an annular element with a central point, an inner side, an outer side, and at least one pole element which is positioned on the inner side of the annular element and extends in a radial direction to the central point of the annular element. The pole element includes a pole tooth that has a first pole tooth end, a second pole tooth end, an upper side, a first lower side, and a second lower side. The pole tooth contains at least one flow barrier element.

This application claims the priority of International Application No. PCT/EP2014/076045, filed Dec. 1, 2014, and European Patent Document No. 13195701 1, filed Dec. 4, 2013, the disclosures of which are expressly incorporated by reference herein.

### BACKGROUND AND SUMMARY OF THE INVENTION

The present invention relates to a stator core for use in an electromagnetic machine. To this end, the stator core comprises at least a first lamination and a second lamination each having an annular element with a center point, an inner side and an outer side, as well as one pole element, which is positioned on the inner side of the annular element and extends in a radial direction to the center point of the annular element, wherein the pole element has a pole tooth with a first pole tooth end, a second pole tooth end, an upper side as well as a first lower side and a second lower side.

In addition, the present invention relates to a lamination for use in the stator core according to the invention.

Stator cores (frequently also known as laminated cores) are generally known in prior art and form a key component of a stator (or also stationary element) for an electromagnetic machine. The electromagnetic machine may be an electric motor, a generator, a hydraulic motor, or a pump. In this context, a stator refers to the fixed, stationary part of an electromechanical machine and forms so to say the counterpart to a rotor or rotating element, which in turn is the moveable part of an electromechanical machine.

Inside the stator, there is a rotor, which in most cases consists of a coil with an iron core (the so-called armature) and is rotatably seated in the magnetic field between the pole shoes of the stator.

The stator typically consists of a cylindrical stator core, which is formed from a plurality of laminations that are stacked on top of and connected to each other. After the individual laminations are joined to form the laminated core, the laminated core and particularly the grooves between the individual pole shoe elements are lined with a plastic insulation layer.

Such a stator package according to prior art, which consists of a plurality of laminations arranged next to each other, is depicted in DE patent application 10 2009 020 481 A1. This prior art document discloses a reluctance motor having a rotor and a stator. On the stator, there are formed freestanding stator poles that are surrounded by (coil) windings. For the electrical insulation of the (coil) windings against the stator, the stator poles as well as the stator walls extending between the stator poles in the peripheral direction are covered by a winding body designed as a plastic injection-molded part (i.e., insulation element). This winding body is designed in a shell-like manner to line the stator region flanking the (coil) windings.

One problem of these prior art stator cores is that the plastic insulation layer for avoiding short-circuits is not applied optimally between the pole element and the winding coil on the inner side of the stator core. “Optimally” hereby means that this plastic insulation layer is applied not too thickly nor too thinly, since a too thickly applied plastic means an excessively elevated thermal insulation of the stator core and a too thinly applied plastic does not have sufficient insulation strength.

The problem is caused particularly by the fact that typically a relatively large amount or thick layer of plastic insulation is built up on the two ends of a pole tooth. This large quantity of plastic insulation, shaped in a corresponding form, serves as a supporting or restraining element for the coil winding wound around the pole arm to hold it securely in position on the pole arm. In contrast to this, the plastic insulation layer on the remaining parts of the pole element and particularly on the inner side of the stator core is thinner than on the end of the stator tooth. The thinnest possible layer of plastic insulation is advantageous for good dissipation of undesired heat from the inside of the stator core, which occurs due to the winding coils. It may hereby happen that the plastic insulation layer is twice as thick as on the other parts of the stator core.

To actually apply the plastic insulation layer, one often pours, at one end of the stator core, the liquid plastic insulation into the stator core. Because more plastic must be applied at the end of the pole tooth than at the base of the pole element for example, and the greater quantity of plastic insulation flows more slowly than the smaller quantity of plastic insulation, it can occur that the two different quantities do not arrive simultaneously at the opposite end of the stator core. As a result, it can happen that the smaller quantity of plastic insulation already cools and hardens at the end of the stator core before the larger quantity of plastic insulation has also arrived at this end of the stator core. Due to the differing temperatures and the associated differing degrees of hardness of the two plastic quantities, undesired flow lines in the plastic insulation may occur at the location at which these two unequal quantities ultimately come together in the stator core. In addition, the slower speed of the larger plastic quantity generally delays the entire coating process.

Furthermore, the larger quantity of plastic insulation, which serves as a supporting or restraining element for the coil winding wound around the pole arm, presents a major problem for optimal dissipation of undesired heat, caused by the coil winding, from inside the stator core.

The object of the present invention is to solve these aforementioned problems and particularly to achieve the most optimal insulation on the pole elements and inner side of the stator core respectively. In addition, another object of the present invention consists of keeping the iron content (i.e., iron in the form of electrical sheet) in the stator core as low as possible. In other words, the aim is to ensure that the iron content in the stator core is only as large as is necessary for generating the magnetic flux in the stator core. By reducing the iron content, the stator core can be manufactured in a more lightweight manner and more economically in terms of material costs.

By means of the subject matter of the present invention, a stator core is provided for use in an electromagnetic machine, which comprises at least a first lamination and a second lamination each having an annular element with a center point, an inner side and an outer side, as well as at least one pole element, which is positioned on the inner side of the annular element and extends in a radial direction toward the center point of the annular element, wherein the pole element has a pole tooth with a first pole tooth end, a second pole tooth end, an upper side as well as a first under side and a second lower side.

In addition, another object of the present invention is to provide a lamination for use in the stator core according to the invention.

According to the invention, the pole tooth comprises at least one flow barrier element.

By means of the flow barrier element, the flow speed of a plastic insulation applied in a fluid state is reduced, whereby an optimal plastic insulation layer is achieved. The optimal plastic insulation generated by the presence of the flow barrier element is distinguished particularly by a uniformly thin thickness while simultaneously having a high dielectric strength. In addition, one can achieve very good heat conductivity with low insulation resistance thanks to the uniformly thin thickness of the plastic insulation.

The flow barrier element is not electromagnetically active in every configuration, so that the magnetic flux at the pole element is not negatively influenced.

According to an advantageous embodiment of the present invention, the flow barrier element is arranged on the first pole tooth end and/or the second pole tooth end. By the positioning of a flow barrier element at each of the first and/or second pole tooth ends, the flow speed of the liquid insulation material is optimally reduced and simultaneously a suitable support or restraining element is provided for the coil winding wound around the pole arm. The flow barrier element can thereby be positioned on the lower side of the pole tooth and/or on the pole tooth end.

By means of the optional design of the flow barrier element in the form of at least a first projection protruding from the pole tooth and/or a second projection protruding from the pole tooth, one can ensure that the speed of the liquid insulation material is effectively reduced and the coil winding wound around the pole arm can be restrained. The projection can thereby be designed in the shape of an elongated strip or rib. Alternatively, the projection can also have any other suitable shape.

According to another advantageous embodiment, it may be provided that the first projection is larger than the second projection. By the variably sized design of the first and second projections, one can optimally adapt the flow barrier element to the exterior contour of the pole tooth.

To generate as much turbulent flow as possible for the liquid insulation material, it is advantageous according to an additional embodiment if the flow barrier element of a first lamination is in a first position on the pole tooth and the flow barrier element of a second lamination is at a second position on the pole tooth. In addition, it is also possible that the first position of the flow barrier element of the first lamination on the pole tooth is arranged in an offset manner to the second position of the flow barrier element of the second lamination on the pole tooth. By these differing positions of the flow barrier elements on the individual laminations, a fissured and thus not continuous flow channel can be created, through which the liquid insulation material slowly flows. As already described above, the object of the present invention is among other things to keep the iron content (i.e., iron in the form of electrical sheet) in the stator core as low as possible, i.e., only as large as is necessary to generate the magnetic flux in the stator core. By means of the insulation material (in the form of a plastic), which is applied on the pole elements (i.e., inner side of the stator core), the necessary air and leakage paths can in turn be maintained for the stator core. However, the insulation material cannot be applied in an absolutely homogeneous manner on the pole elements (i.e., on the inner side of the stator core), so that a non-homogeneous (heterogeneous) thickness of the insulation material results. To counteract the effects of this non-homogeneous (heterogeneous) thickness of the insulation material, the offset arrangement (described above) of the flow barrier elements from one lamination to another is suitable, by means of which a fissured and thus non-continuous flow channel results on the individual laminations.

Additional advantages emerge in the following drawing descriptions. The drawings depict an embodiment of the present invention. The drawings, the description, and the claims contain numerous features in combination. A person skilled in the art will for practical purposes also consider the features individually and combine them into other sensible combinations.

### BRIEF DESCRIPTION OF THE DRAWINGS

FIG. 1 a perspective view of a stator core according to the invention consisting of a plurality of individual laminations arranged in a row one behind the other and connected to each other according to a first embodiment;

FIG. 2 a frontal view of lamination with pole elements and flow barrier elements according to the first embodiment;

FIG. 3 detailed views of the flow barrier elements according to the first embodiment according to the sections in FIG. 2;

FIG. 4 additional detailed views of the flow barrier elements on the lower sides of the pole teeth according to the first embodiment;

FIG. 5 a perspective view of a stator core according to the invention consisting of a plurality of individual laminations arranged in a row one behind the other and connected to each other according to a second embodiment;

FIG. 6 a frontal view of stator core consisting of laminations with pole elements and flow barrier elements according to the second embodiment;

FIG. 7 a sectional view along the stator core according to the second embodiment;

FIG. 8 a detailed view of the flow barrier elements at the lower sides of the pole teeth according to the second embodiment;

FIG. 9 a perspective view of the stator core with an insulation layer on the inner side of the stator core;

FIG. 10 a frontal view of the stator core with an insulation layer on the inner side of the stator core;

FIG. 11 a perspective view of the stator core with a single insulation layer on the inner side of the stator core; and

FIG. 12 a perspective view of a single segment of the insulation layer.

### DETAILED DESCRIPTION OF THE DRAWINGS

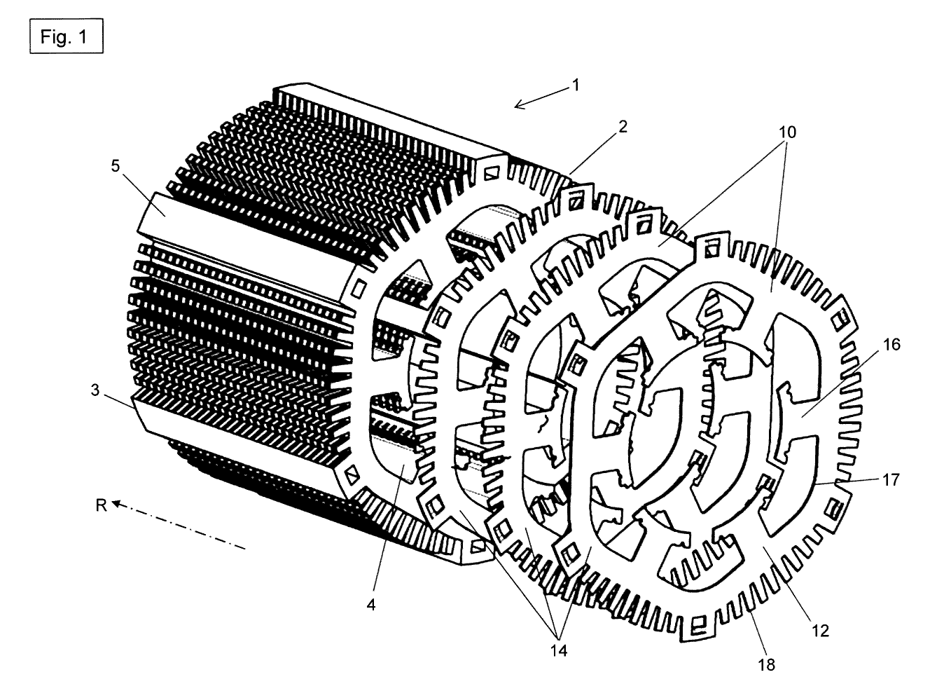

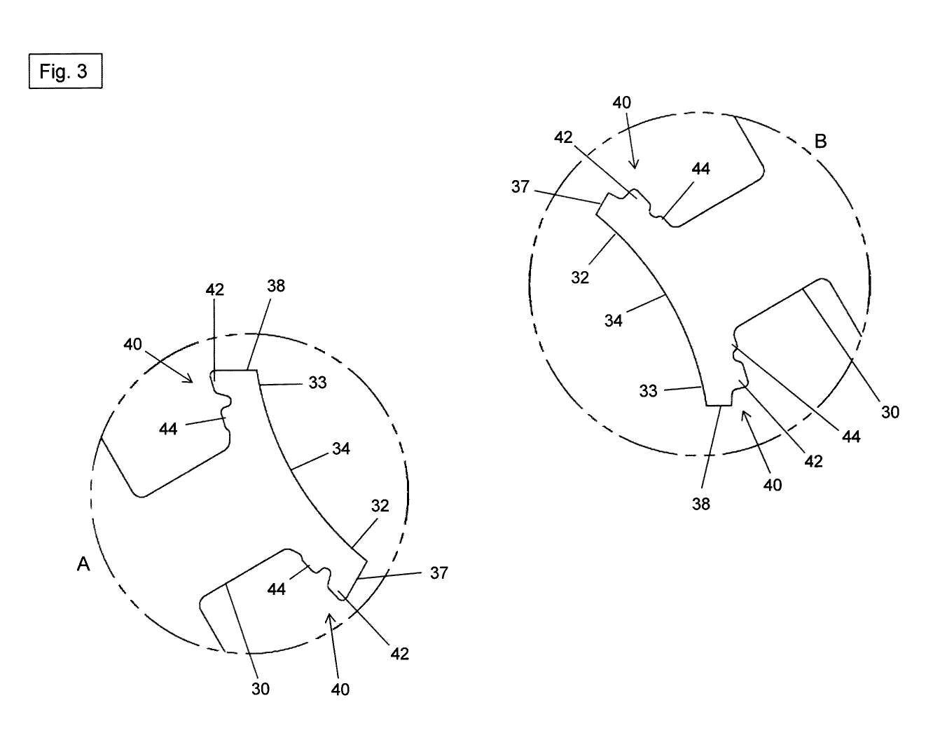

FIGS. 1 to 4 depict a stator core 1 according to the invention and pursuant to a first embodiment. FIG. 1 hereby depicts in particular in a perspective view a stator core 1 according to the invention pursuant to a first embodiment. Stator core 1 contains a plurality of laminations 10 arranged in a row next to each other.

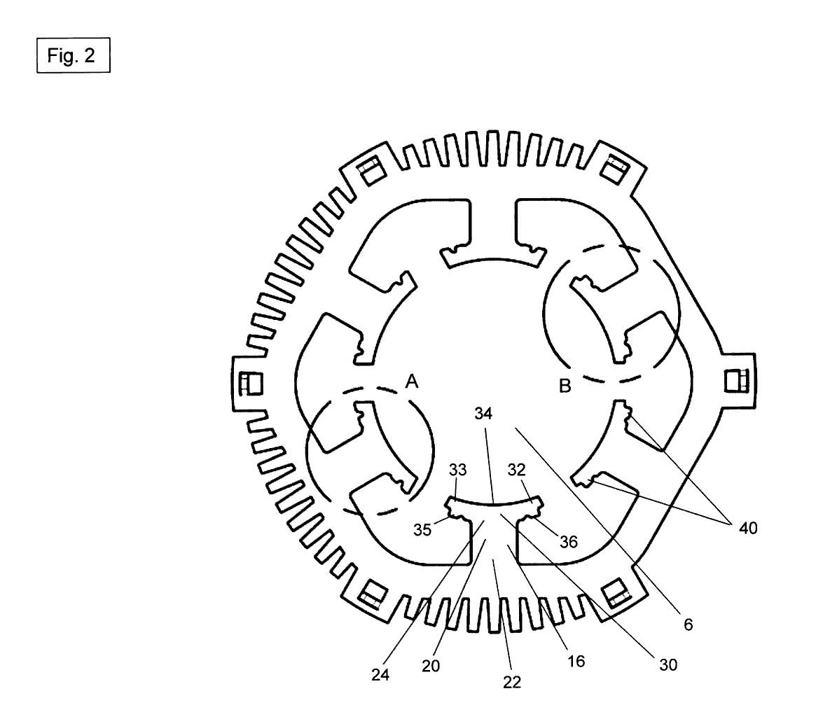

As depicted in FIGS. 1 and 2, each lamination 10 in turn contains a front side 12, a (not depicted) rear side, a circular annular element 14 with a center point, pole elements 16, an inner side 17, and an outer side 18.

To form a stator core 1, individual laminations 10 are arranged in a row next to and connected to each other. Stator core 1 thus has a cylindrical shape with a first stator end 2, a second stator end 3, an inner side 4, an outer side 5, and a centric opening 6. In this centric opening 6, one can insert and rotatably seat a (not depicted) rotor.

On inner side 12 of annular element 14, there are positioned individual pole elements 16. Each pole element 16 contains a rectangular pole arm 20 with a first pole arm end 22 and a second pole arm end 24. First pole arm end 22 is rigidly connected to inner side 12 of annular element 14 and serves, among other things, to accommodate a non-depicted coil winding that consists of coil wire. On the second pole arm end 24, there is a pole tooth 30. Pole tooth 30 has a slightly curved sickle shape and contains a first pole tooth end 32, a second pole tooth end 33, a continuous upper side 34, a first lower side 35 as well as a second lower side 36. First pole tooth end 32 and second pole tooth end 33 are opposite each other and form a first lateral outer surface 37 and a second lateral outer surface 38 on pole tooth 30.

Pole arm 20 extends with second pole arm end 24 and pole tooth 30 in a radial direction to the center point of circular annular element 14.

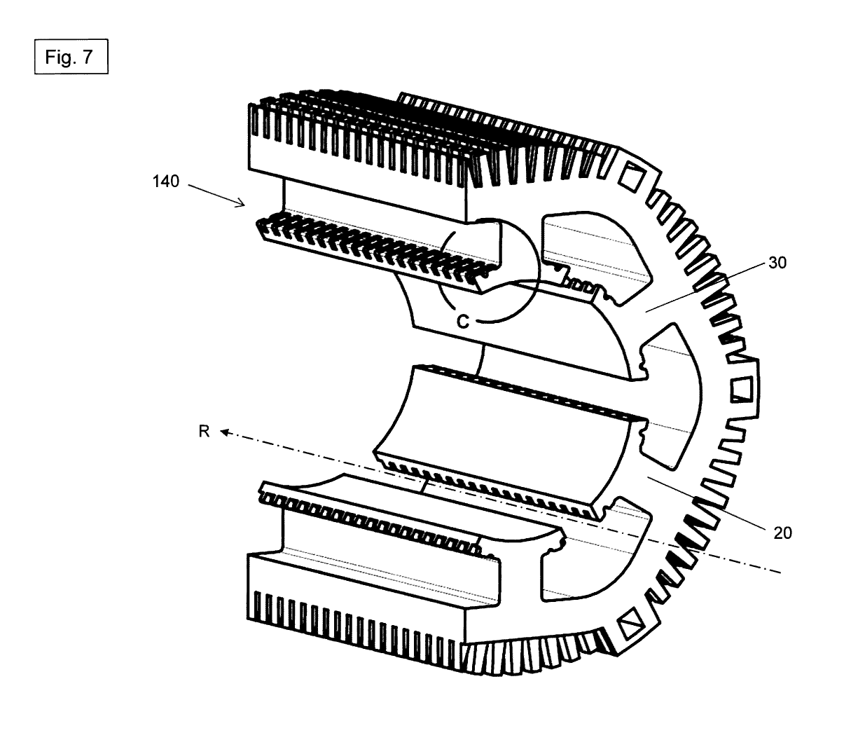

According to an alternative (not depicted) embodiment, stator core 1 may also contain a plurality of stator core segments. Each of the stator core segments hereby contains at least one pole element (cf. FIG. 7). The stator core segments are connected to each other by means of (not depicted) connection elements in such a manner that the cylindrical shape of the stator core results. The connection elements may be plug, slide, click, or adhesive connections.

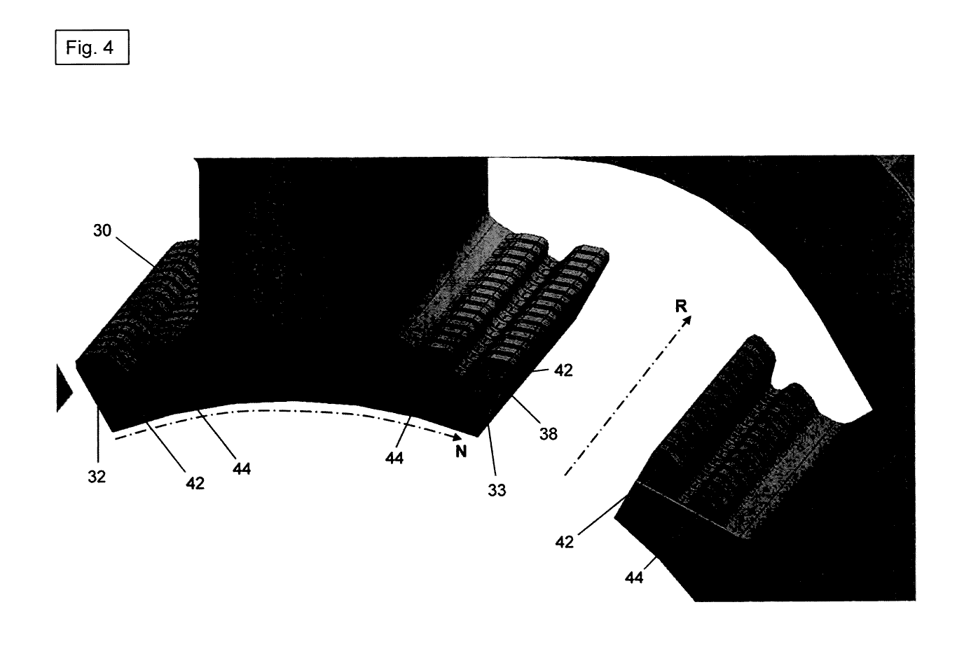

As also depicted in FIGS. 1 to 4 and pursuant to the first embodiment of stator core 1 according to the invention, a flow barrier element 40 is positioned on the first lower side 35 and on the second lower side 36 of each pole tooth 30. This flow barrier element 40 is, in each case, thereby designed essentially in the form of a first rounded projection 42 and a second rounded projection 44. First projection 42 and second projection 44 each extend toward inner side 17 of circular annular element 14. First projection 42 is designed somewhat larger than second projection 44. In addition, first projection 42 is located farther from pole arm 20 than second projection 44. Between first projection 42 and second projection 44, there is provided a rounded recess in the shape of a depression. By means of first and second projections 42, 44, and rounded recess, there results on first lower side 35 as well as at second lower side 36 of pole tooth 30 a continuous channel in the longitudinal extension of stator core 1 in direction R, and a wave-shaped surface in peripheral direction N; cf. FIG. 4.

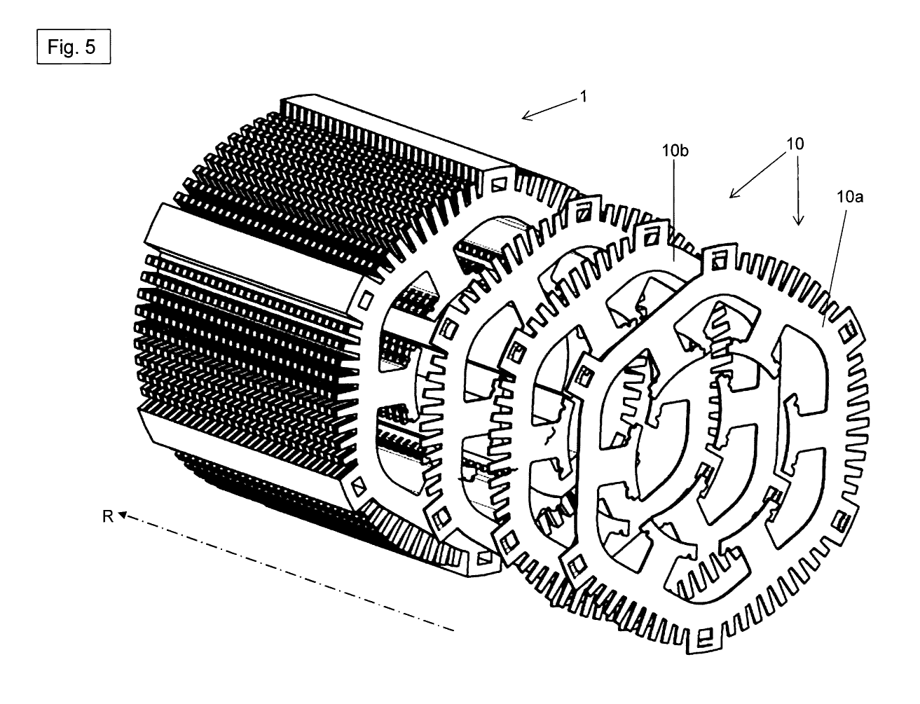

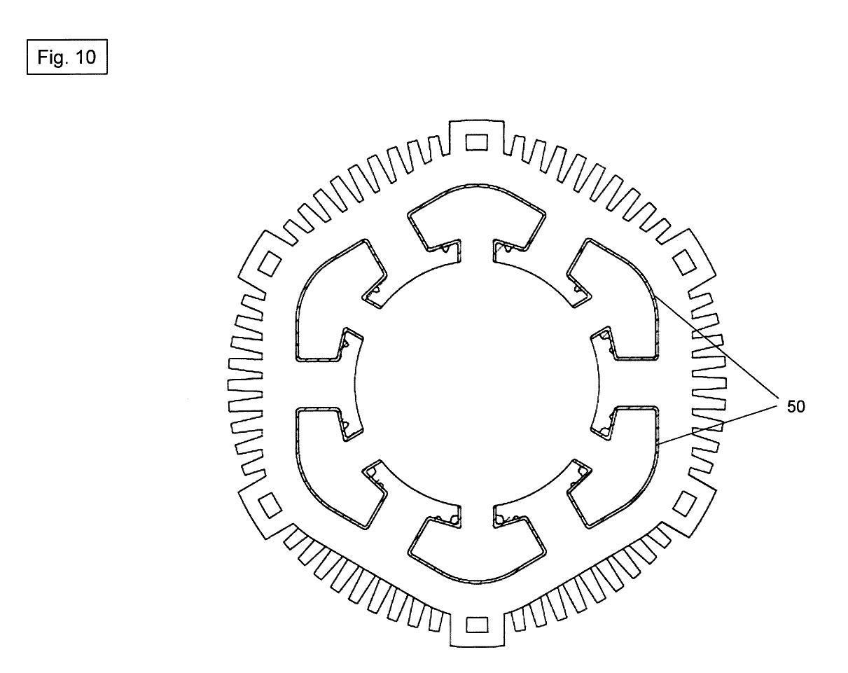

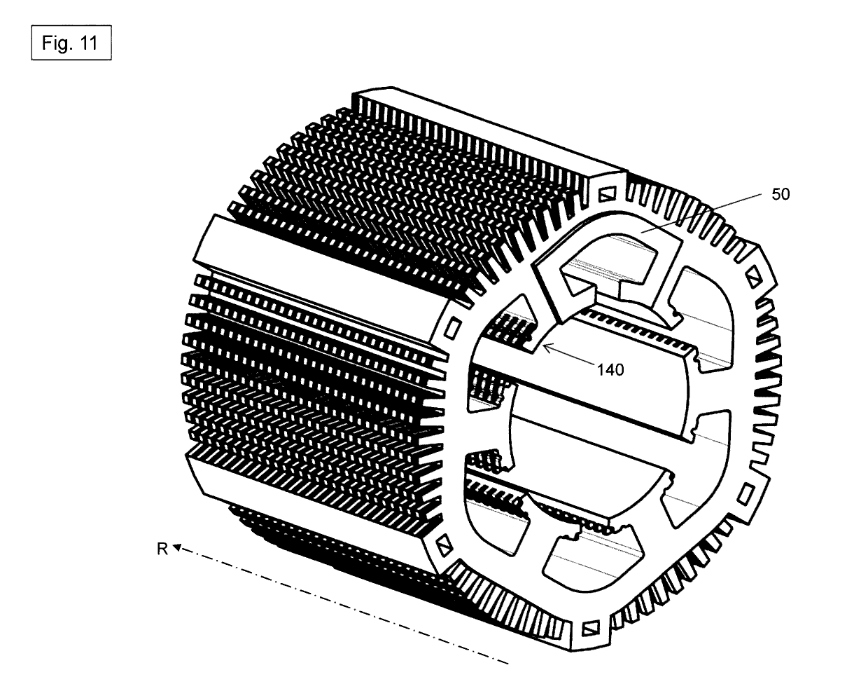

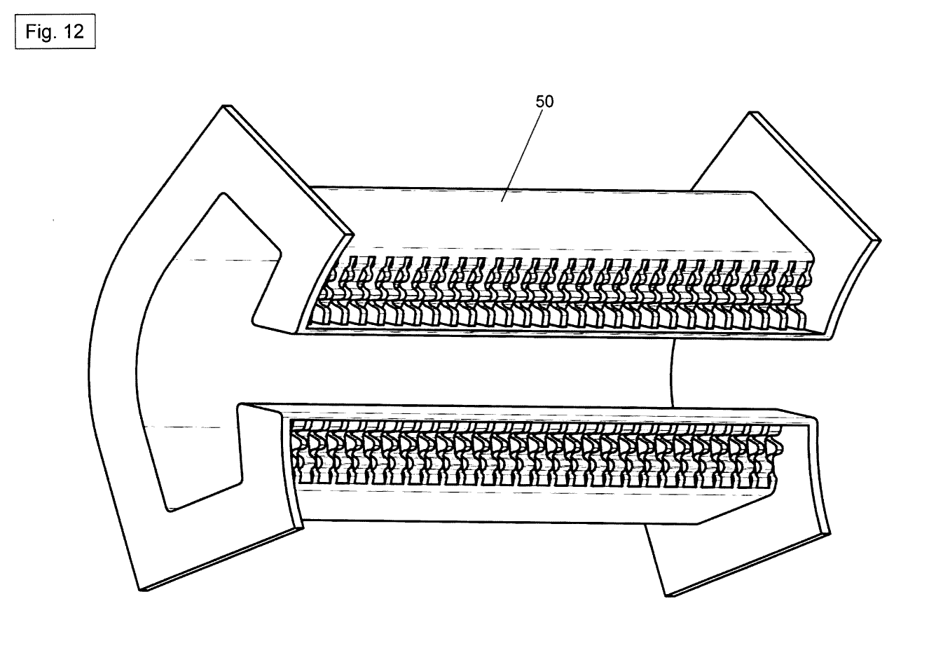

FIGS. 5 to 12 depict a stator core 1 according to the invention pursuant to a second embodiment.

FIG. 5 hereby depicts a perspective view of stator core 1 according to the invention pursuant to a second embodiment. As depicted in FIG. 5, stator core 1 contains a plurality of laminations 10 arranged in a row one next to the other. Laminations 10 thereby have various thicknesses, i.e., stator core 1 consists of a first thick lamination 10a as well as a second thin lamination 10b, with each alternating from one to another. In addition, the design of lamination 10 according to the second embodiment corresponds essentially to the design of lamination 10 according to the first embodiment.

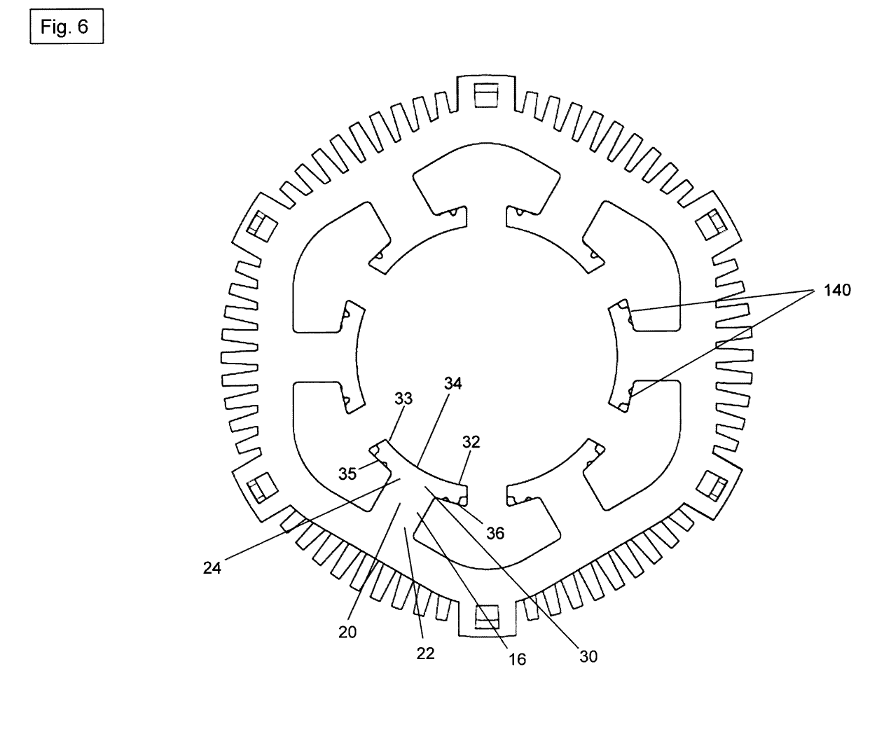

As depicted in FIG. 6, pursuant to the second embodiment of stator core 1 according to the invention, a flow barrier element 140 is positioned at first lower side 35 and at second lower side 36 of each pole tooth 30.

Flow barrier element 140 according to the second embodiment is thereby designed essentially in the shape of a first rectangular projection 142 with rounded-off corners and a second rectangular projection 144 with rounded-off corners on lower sides 35, 36 of pole tooth 30. First projection 142 and second projection 144 each extend toward inner site 17 of circular annular element 14.

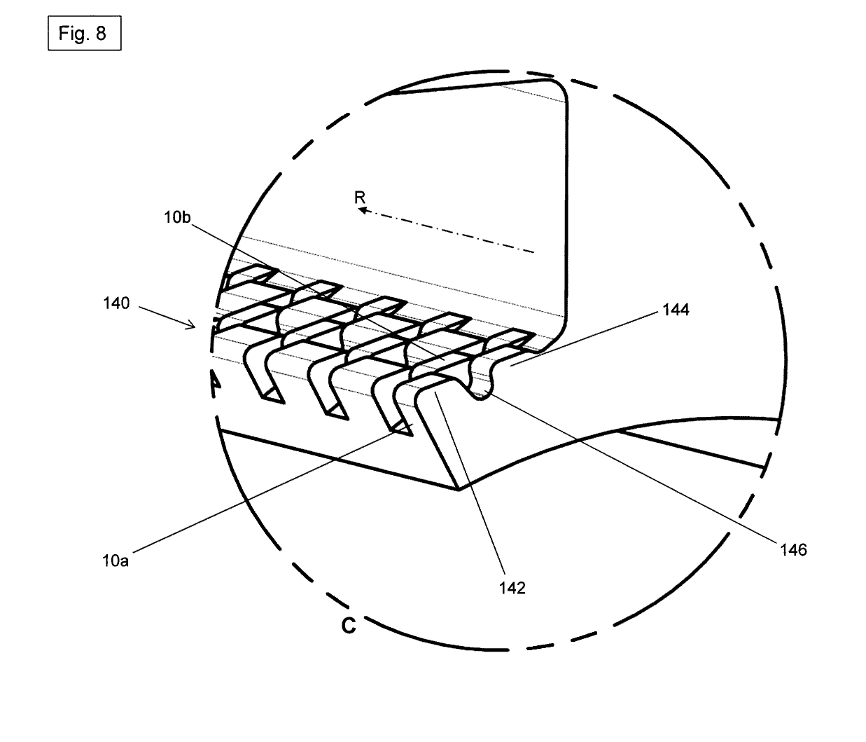

In contrast to the first embodiment, in the second embodiment, first projection 142 and second projection 144 have the same heights as the lower sides 35, 36 of each pole tooth 30. Between first projection 142 and second projection 144, there is provided a rounded recess 146 in the form of a depression. However, the position of first projection 142 and the position of second projection 144 are not identical on lower sides 35, 36 of pole teeth 30 of the individual laminations 10, but arranged offset to each other. This means that first projection 142 of a flow barrier element 140 on a first thick lamination 10 is located at a different position than first projection 142 of a flow barrier element 140 on a second thin lamination 10b; cf. FIGS. 7 and 8.

Furthermore, second projection 144 of a flow barrier element 140 on a first thick lamination 10a is located at a different position than first projection 142 of a flow barrier element 140 on second thin lamination 10b. First projection 142 of a flow barrier element 140 on the first thick lamination 10 is thereby located in direction R between first projection 142 and second projection 144 of a flow barrier element 140 on second lamination 10b.

By this offset positioning of first projection 142 and second projection 144 on respective pole teeth 30 of individual laminations 10a, 10b, there are no continuous channels or passages (in contrast to the first embodiment), but instead individual recesses 146 arranged offset to each other along lower sides 35, 36 of pole teeth 30 in direction R.

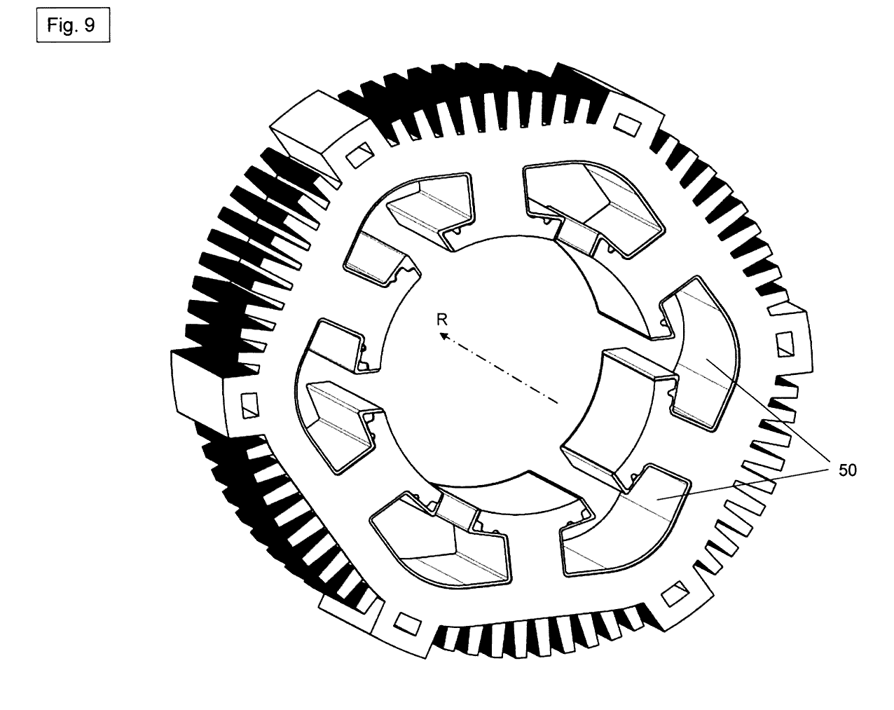

To apply an insulating layer 50 to inner side 4 of stator core 1, as depicted in FIGS. 9 to 11, the liquid plastic insulation material runs from stator end 2 in direction R to stator end 3. The objective in applying this liquid plastic insulation is an even (i.e., without flow lines) and uniformly thick insulation layer 50 on all points of inner side 4 of stator core 1. This means that this insulation layer 50 should not be too thick nor too thin. An excessively thick insulation layer 50 thereby results in a degraded dissipation of heat at the outer side 5 of stator core 1, which results from the (not depicted) coil winding inside stator core 1. In contrast, an excessively thin insulation layer 50 does not offer any sufficient impact strength against mechanical forces.

As depicted particularly in FIG. 4 and described above, flow barrier elements 40 according to the first embodiment allow only small passageways or channels to be created at pole teeth 30, through which the liquid insulation material must flow from first stator end 2 to second stator end 3. By means of these small channels, the flow speed of the liquid insulation material is reduced so that the insulation material at inner side 4 of stator core 1 has (approximately) the same flow speed as the insulation material on lower sides 35, 36 of pole teeth 30. One can hereby achieve that the flows of insulation material on inner side 4 of stator core 1 and at pole teeth 30 flow (approximately) equally fast and therefore arrive at (approximately) the same time at second stator end 3. By means of the (approximately) simultaneous meeting of the first insulation material flow at inner side 4 of stator core 1 and the second insulation material flow on pole teeth 30, the temperature of these two flows is (approximately) equal, whereby undesired flow lines are avoided at the location where the two flows meet, and a continuously uniform and smooth insulation layer can be achieved on inner side 4 of stator core 1.

In contrast to the first embodiment, there are in the second embodiment no small passageways or channels on lower sides 35, 36 of pole teeth 30 resulting from flow barrier elements 140 arranged in an offset manner, but instead (as already described above) there are created recesses 146, arranged offset to each other, along lower sides 35, 36 of pole teeth 30 in direction R. When applying an insulation layer 50 on inner side 4 of stator core 1, the liquid insulation material flows from first stator end 2 to second stator end 3. By means of recesses 146 arranged in an offset manner, the flow speed of the liquid insulation material along lower sides 35, 36 of pole teeth 30 is effectively reduced, since the liquid insulation material cannot flow along a smooth surface, but must move alternatingly over the individual projections 142, 144 and recesses 146 of the flow barrier elements. One can hereby also achieve that the flows of insulation material flow (approximately) equally fast on inner side 4 of stator core 1 and at pole tooth ends 30 and thereby arrive (approximately) simultaneously at second stator end 3. By means of the (approximately) simultaneous meeting of the first insulation material flow on inner side 4 of stator core 1 and the second insulation material flow on pole teeth 30, the temperature of these two flows is (approximately) equal, by means of which undesired flow lines at the meeting location of the two flows can be avoided and a continuously uniform and smooth insulation layer 50 can be achieved on inner side 4 of stator core 1.

In addition, by means of flow barrier elements 40, 140, insulation layer 50 can also be applied in an optimal thickness (i.e., neither too thin nor too thick) at pole teeth 30, without having to forego a support or restraint element for the coil winding wound around pole arm 20 or generating an increase in the magnetic flux density, which can result in magnetic saturation on pole element 16. An optimally strong or thick insulation layer 50 is emplaced by their application on the individual flow barrier elements 40, 140 designed as projections, and it flows (slowly) between the individual flow barrier elements 40, 140. Because the distances between the individual flow barrier elements 40, 140 corresponds only maximally to twice the thickness of insulation layer 50 to be applied, one can ensure that insulation layer 50 is also applied between individual flow barrier elements 40, 140 and collectively on pole teeth ends 32, 33 with an optimal thickness, i.e., neither too thin nor too thick.

1.-7. (canceled)

8. A stator core for use in an electromagnetic machine, comprising:
a first lamination and a second lamination, wherein the first lamination and the second lamination are arranged in a row next to one another;
wherein each of the first lamination and the second lamination has:
an annular element with a central point, an inner side, and an outer side; and
a pole element disposed on the inner side and extending in a radial direction to the central point, wherein the pole element includes a pole tooth that has a first pole tooth end, a second pole tooth end, an upper side, a first lower side, a second lower side, and a flow barrier element.

9. The stator core according to claim 8, wherein the flow barrier element is disposed on the first pole tooth end and/or on the second pole tooth end.

10. The stator core according to claim 8, wherein the flow barrier element is a first projection protruding from the pole tooth and a second projection protruding from the pole tooth.

11. The stator core according to claim 10, wherein the first projection is larger than the second projection.

12. The stator core according to claim 8, wherein the respective flow barrier element of the first lamination is located at a first position on the respective pole tooth and wherein the respective flow barrier element of the second lamination is located at a second position on the respective pole tooth.

13. The stator core according to claim 12, wherein the first position is offset with respect to the second position.

14. A lamination for use in a stator core, comprising:
an annular element with a central point, an inner side, and an outer side; and
a pole element disposed on the inner side and extending in a radial direction to the central point, wherein the pole element includes a pole tooth that has a first pole tooth end, a second pole tooth end, an upper side, a first lower side, a second lower side, and a flow barrier element.

15. The lamination according to claim 14, wherein the flow barrier element is disposed on the first pole tooth end and/or on the second pole tooth end.

16. The lamination according to claim 14, wherein the flow barrier element is a first projection protruding from the pole tooth and a second projection protruding from the pole tooth.

17. The lamination according to claim 16, wherein the first projection is larger than the second projection.
